(19) United States
(12) Patent Application Publication
(10) Pub. No.: US 2016/0226800 A1
(43) Pub. Date: Aug. 4, 2016

(54) Safety Intact

(71) Applicants: Tammy Alo, Ewa Beach, HI (US); Brandie Mendiola, Wahiawa, HI (US)

(72) Inventors: Tammy Alo, Ewa Beach, HI (US); Brandie Mendiola, Wahiawa, HI (US)

(21) Appl. No.: 15/096,278

(22) Filed: Apr. 12, 2016

(51) Int. Cl. H04L 12/58; G06Q 50/26; G06F 3/0482; G06Q 50/00; G06F 3/0484; G06F 17/22

(52) U.S. Cl. CPC H04L 51/046; H04L 51/32; G06F 3/04842; G06F 17/2235; G06F 3/0482; G06Q 50/01; G06Q 50/265

(57) ABSTRACT

Safety Intact is an ingenious website where individuals can go to and access information all about safety. We made a user friendly website and have provided a more efficient and time saving solution. Furthermore, Members are able to communicate with Safety Professionals, First responders, Attorneys and other members through live stream video and text capabilities. Members may choose to post their resumes and display their first name and credentials. Safety Intact has provided public domains to access safety links both Federally and by State and also U.S. Territory. Users can find information to be able to get certified through OSHA for numerous safety-training courses. Additionally, choose from stores to shop for safety equipment. For the prevention and educational purpose view reactive videos and images of accidents that occurred.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

There is technology similar to the invention such as; Facebook, Face Time, LinkedIn, Skype, Tango, Instagram and Snapchat, there are a plethora of these websites. Safety Intact is a safety platform website. Containing information only in relation to any and all safety. The problem is that there are many different websites regarding safety but not one that includes ALL safety. There are no collectively online safety platforms to include live communication and live chat/text.

### Problem

We now live in a world where radicals, rebel, terrorist are at our forefront, impending from every angle.

There is no Safety Platform. A place where First Responders, Attorneys, Businesses, you and I can communicate safety needs and concerns. In order to be abreast communication is key.

### Solution

Safety Intact is the first of its kind to have a Safety Platform website which includes Safety Talks and Safety Text aside from public domain links.

We have created a uniquely designed website to provide free safety information along with advanced communication tools created to allocate all safety knowledge.

We would like to introduce Safety Talks. Safety Talks is a feature that provides live stream video chat. There will be a collection of diminutive Safety Talks boxes that will be streaming live.

Safety Text is another feature that will allow members to live chat with others about any and all safety matters.

### BRIEF SUMMARY OF THE INVENTION

Safety Intact is an ingenious idea to connect Safety Professionals, First Responders, Attorneys, Businesses, you and I to communicate online in real time by way of texting and video chat. We have created a live “Safety Talks” where members can stream live regarding safety questions, concerns, and safety suggestions they may have. Such as hazard chemicals, pool safety, slips, trips and falls are some questions the everyday person or businesses may have.

Safety Intact also has Safety Text. This where you can text anyone live regarding safety questions, concerns, and safety suggestions they may have. There is technology similar to the invention however, shared information is not private. Members are able to share skills and knowledge about any and all safety. Safety Intact is a Safety Platform website and is not intended as a social media outlet.

Safety Intact is aimed to educate the public on all aspects of safety and allow everyone to interact with others around the world about safety. Our website is not live as we are currently locating a company to host the site. We have created all the codes for the entire website.

### BRIEF DESCRIPTION OF DRAWINGS

Safety Intact's homepage allows two options to choose from. Membership Area is for paid members. Public Area link are links provided for the public. If you click on the Public Area tab you are directed to public domains of Safety links and from there you have the options of Federal, U.S. States, and U.S. territories to choose from. From there Safety training, reactive videos/images, and safety supplies. If you click on the Membership Area you are directed to safety talks, safety text, safety job announcements and resume posting.

FIG. 1 is the main page and outlines two separate options. Option one is the Public Area. The second option is the Membership Area. Navigation bar 1 will include Home, About Us, Company, Public Area, Guideline Principles, Contact Us, Search bar, and Members/Register. Navigation bar 2 will include Federal Links, State Links, U.S. Territory Links, Safety Training, Reactive Videos/Images, Safety Supplies, and MSDS. See FIG. 2.

FIG. 2 is the Public Area which is the first option that will include Federal Links, State Links, U.S. Territory Links, Safety Training, Reactive Videos/Images, and Safety Supplies. Navigation bar 3 which is located at the bottom the website will include Home, Terms of Use, Public Area, Guideline Principles, Membership, Privacy Policy, and Contact Us. See FIG. 3.

FIG. 3 will be the Federal Links located within the Public Area option. These links will be Federal links to all departments regarding safety to protect, prevent and educate. See FIG. 4.

FIG. 4 will be the State Links of all the 50 states in the United States. Depending on where you live you would click on that specific state. Upon clicking on a State you are led to that specific link and will be leaving Safety Intact. See FIG. 5.

FIG. 5 displays the State Link for Alabama which offers safety information in regards to outdoor safety, fire safety, workplace safety and so forth. Upon clicking on a State you are led to that specific link and will be leaving Safety Intact. See FIG. 6.

FIG. 6 displays the State Link for Alaska which offers safety information in regards to outdoor safety, fire safety, workplace safety and so forth. Upon clicking on a State you are led to that specific link and will be leaving Safety Intact. See FIG. 7.

FIG. 7 displays the State Link for Arizona which offers safety information in regards to outdoor safety, fire safety, workplace safety and so forth. Upon clicking on a State you are led to that specific link and will be leaving Safety Intact. See FIG. 8.

FIG. 8 to FIG. 51 will be the remaining states which will offer safety information in regards to outdoor safety, fire safety, workplace safety and so forth. After choosing a link you will leave Safety Intact's site and enter that specific link chosen. Upon clicking on a State you are led to that specific link and will be leaving Safety Intact. See FIG. 52.

FIG. 52 will be the U.S. Territory Link which will offer a list of the territories and will have links to that specific site. For example, the U.S. Territory Micronesia will include Yap, Chuuk. Pohnpei and Kosrae located within it's website. Here the U.S. Territory chosen is Micronesia. Upon clicking on a Territory you are led to that specific link and will be leaving Safety Intact. See FIG. 53.

FIG. 53 displays the District of Columbia which will have safety information in regards to traveling and so forth. Upon clicking on a Territory you are led to that specific link and will be leaving Safety Intact. See FIG. 54.

FIG. 54 displays the Marshall Islands which will have safety information in regards to traveling and so forth. Upon clicking on a Territory you are led to that specific link and will be leaving Safety Intact. See FIG. 55.

FIG. 55 through FIG. 58 will be the remaining U.S. Territory links which will offer safety information. Upon clicking on a Territory you are led to that specific link and will be leaving Safety Intact. See FIG. 59.

FIG. 59 will be Safety Training where we will offer links to OSHA training, links to the American Society of Safety Engineer Training and so forth. Upon clicking on a training you are led to that specific link and will be leaving Safety Intact. See FIG. 60.

FIG. 60 will be the Reactive Videos/Images which will have accidents that have occurred displayed in diminutive boxes. See FIG. 61.

FIG. 61 will be the Safety Supplies where we will have Stores listed who sell safety supplies. See FIG. 62.

FIG. 62 is Option two which is the Membership Area. Safety Intact requires the customer to agree to the membership policies which include the Public Area and Membership Area. If a customer does not agree to our Membership Policies, they will be directed to the Public Area. See FIG. 63.

FIG. 63 will be the Log-In page where a customer will create a username and password. We will offer a free 7-day trial first but customers will need to enter payment information for the fee of $99.99 per month. Once entered the customer clicks submit and will become a Member. See FIG. 64.

FIG. 64 displays Safety Talks, Safety Text, Resume Posting and Safety Job Announcements. See FIG. 65.

FIG. 65 displays Safety Talks where we will offer 50 diminutive boxes, five boxes across. The first box reads General Industries, the next box will be Construction Industries, next Maritime Industries, next Agriculture Industry, and the last will be Other. The remaining boxes will be labeled the same as the previous five. Members can choose to start the conversation, join in on the conversation or observe. See FIG. 66.

FIG. 66 displays Safety Text where we will offer 50 diminutive boxes, five boxes across. The first box reads General Industries, the next box will be Construction Industries, next Maritime Industries, next Agriculture Industry, and the last will be Other. The remaining boxes will be labeled the same as the previous five. Members can choose to who to text, join in on the text or start a text. See FIG. 67.

FIG. 67 displays Resume Posting where Members can post their resumes for other Members and/or Recruiters to see. There will be a message stating that Resumes will be deleted every 30 days to offer other Members to display their resumes. It is the Members responsibility to reproduce their resumes every 30 days if desired. Resumes will include a Members first name and qualifications only as Safety Intact does not offer Profiles. However, in order for a Member to post their resume they must include first name, last name and email address which will only be shared with Safety Intact. A content box will be provided for the Member to copy and paste their qualifications into. Next, we will choose what category the resume will be in. See FIG. 68.

FIG. 68 displays the Resume Category which allows Members to choose what Industry to submit their resume to. There are 4 categories to choose from General, Construction, Maritime, and Agriculture Industries. A number will be associated with each Resume that is displayed for Recruiters or Companies interested. An interested party will click on the associated number and will be taken to a contact page. See FIG. 69.

FIG. 69 is the Recruiter Contact page where Recruiters and/or Companies who clicked on a number associated with a Members resume can find out how to contact the Member. Here you are asked to enter your first name, email address and are provided a comment box. Once submitted Safety Intact will give your information to that particular Member to contact the Recruiter and/or Company directly.

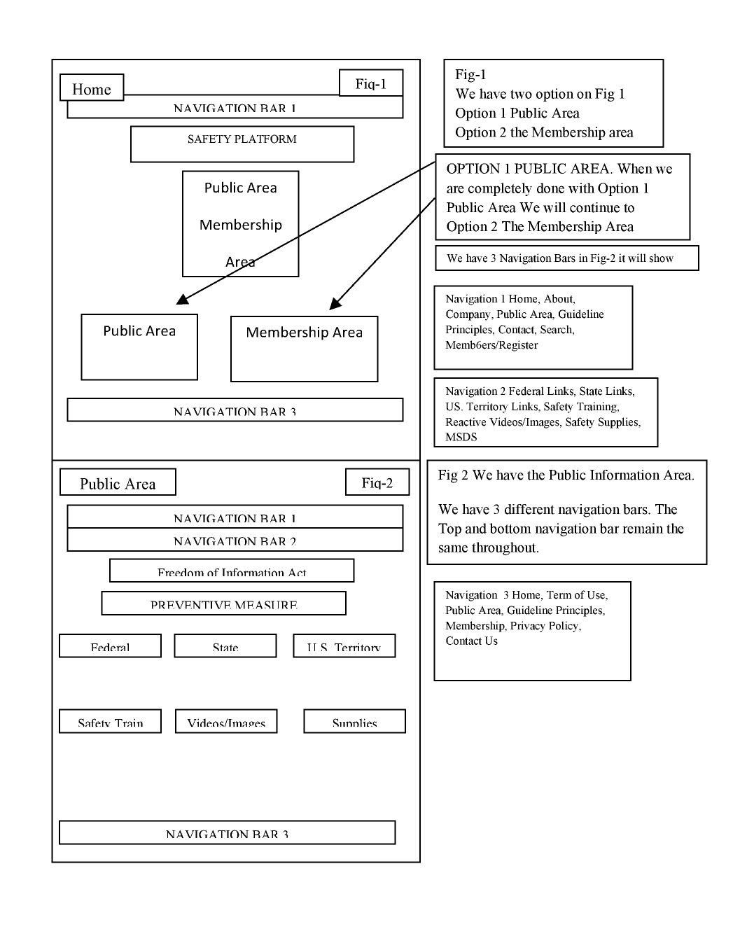

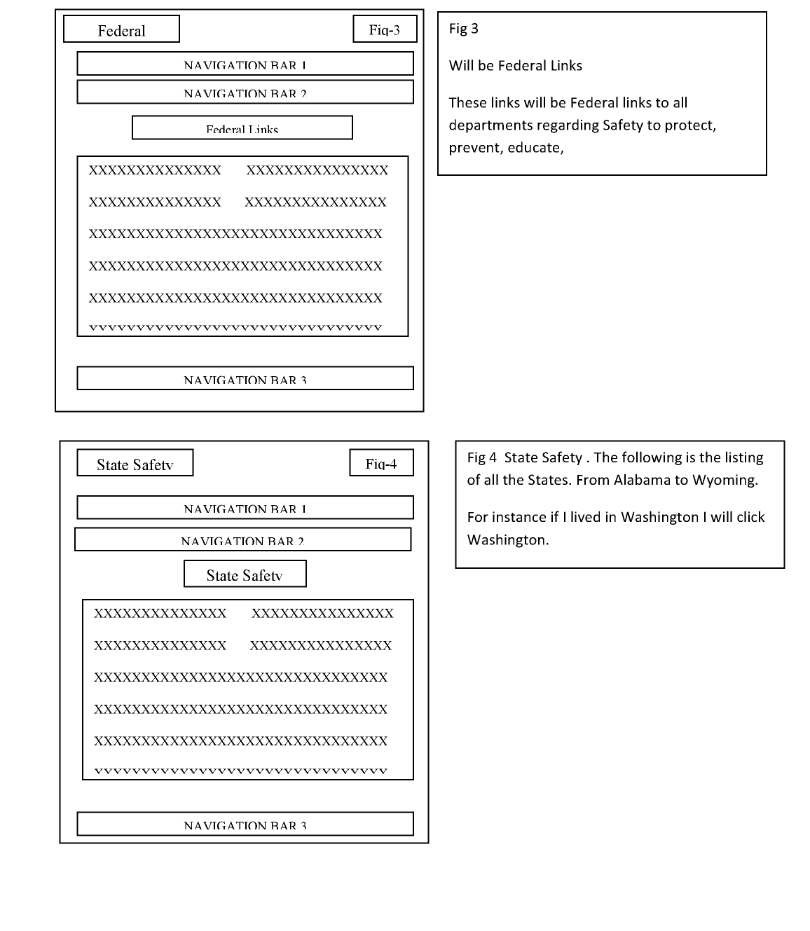

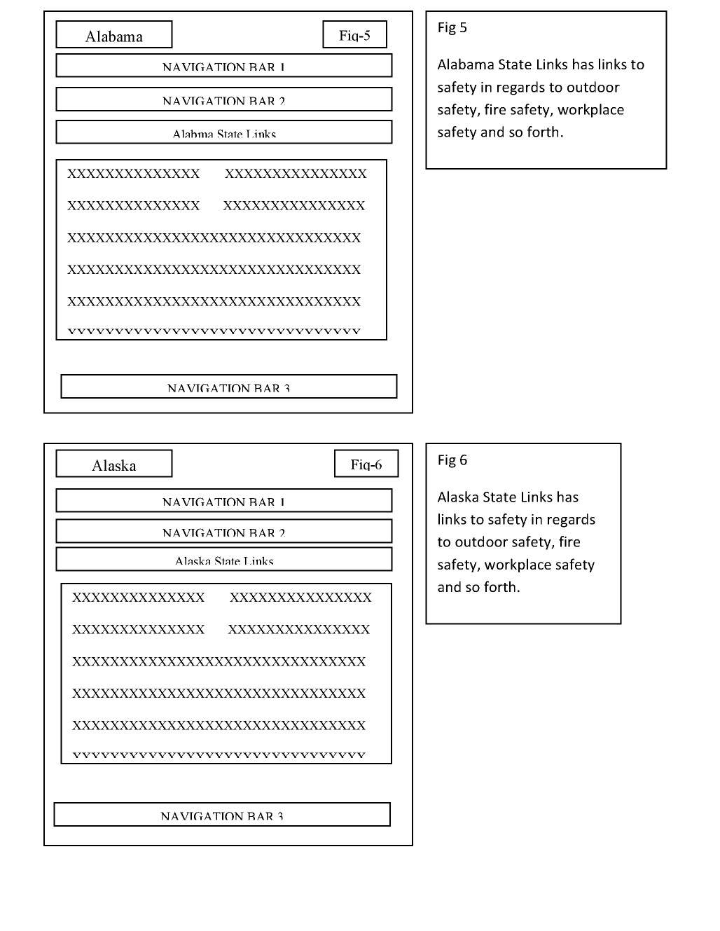

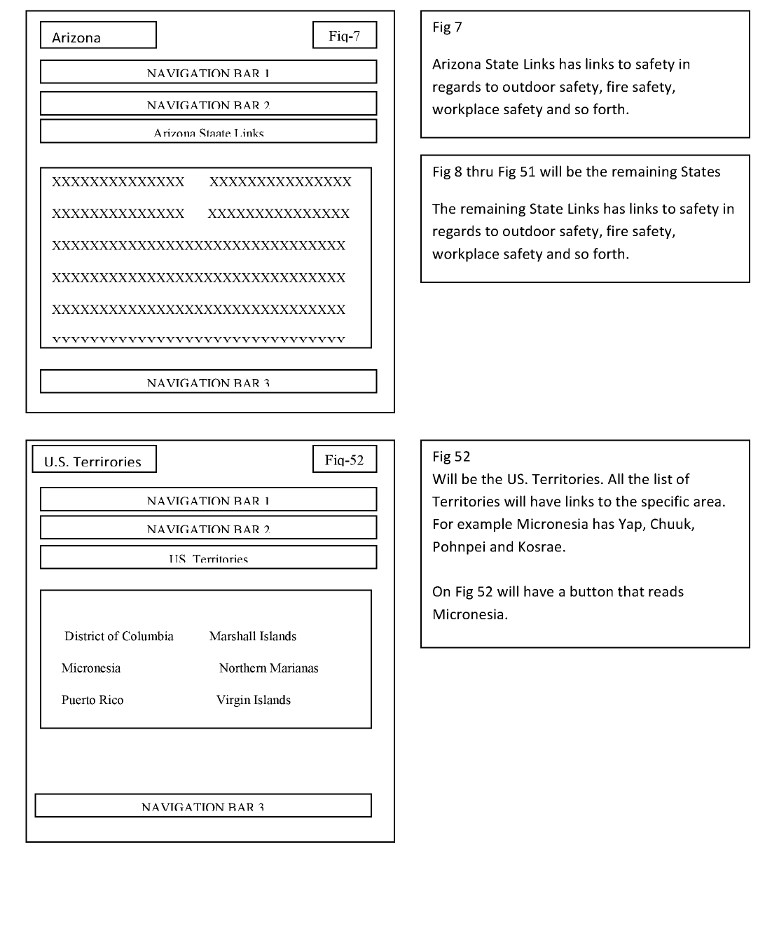

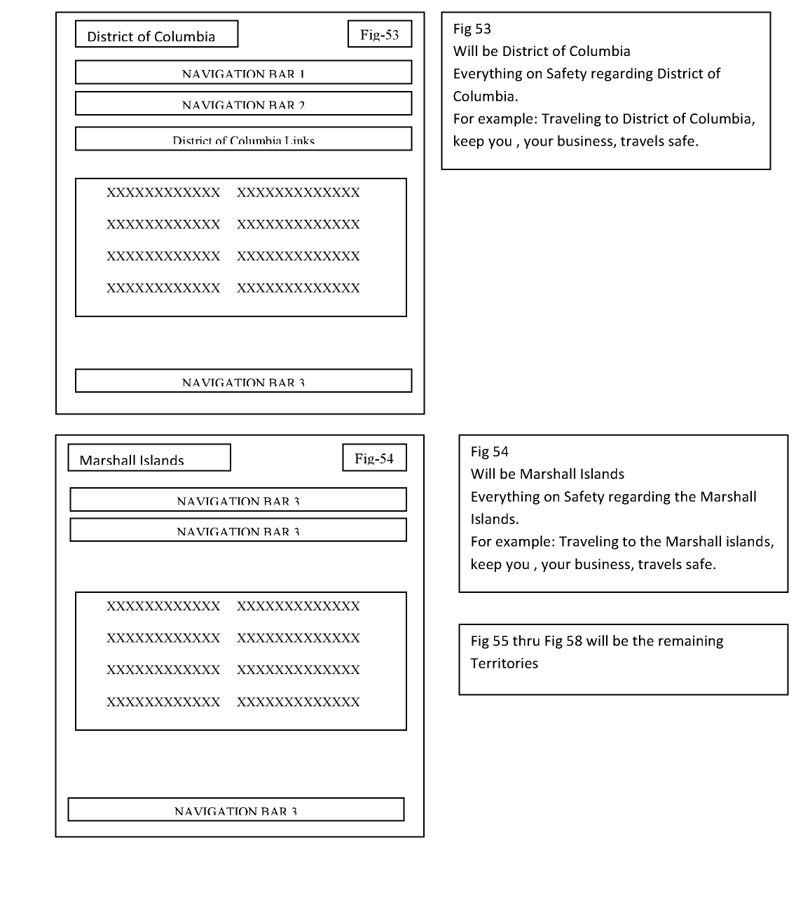

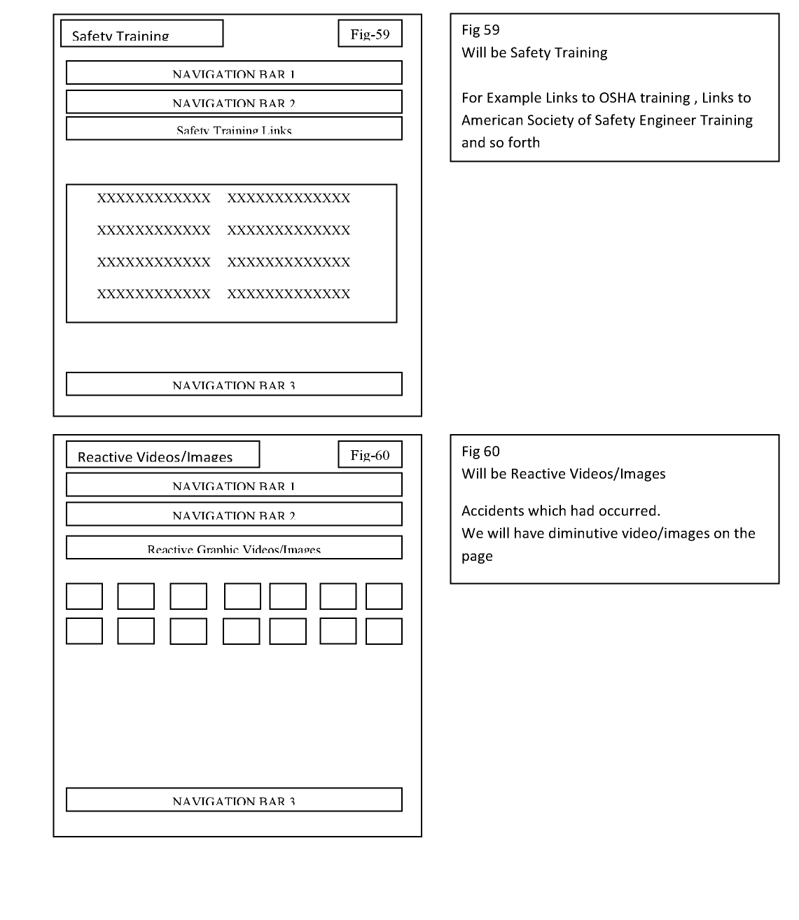

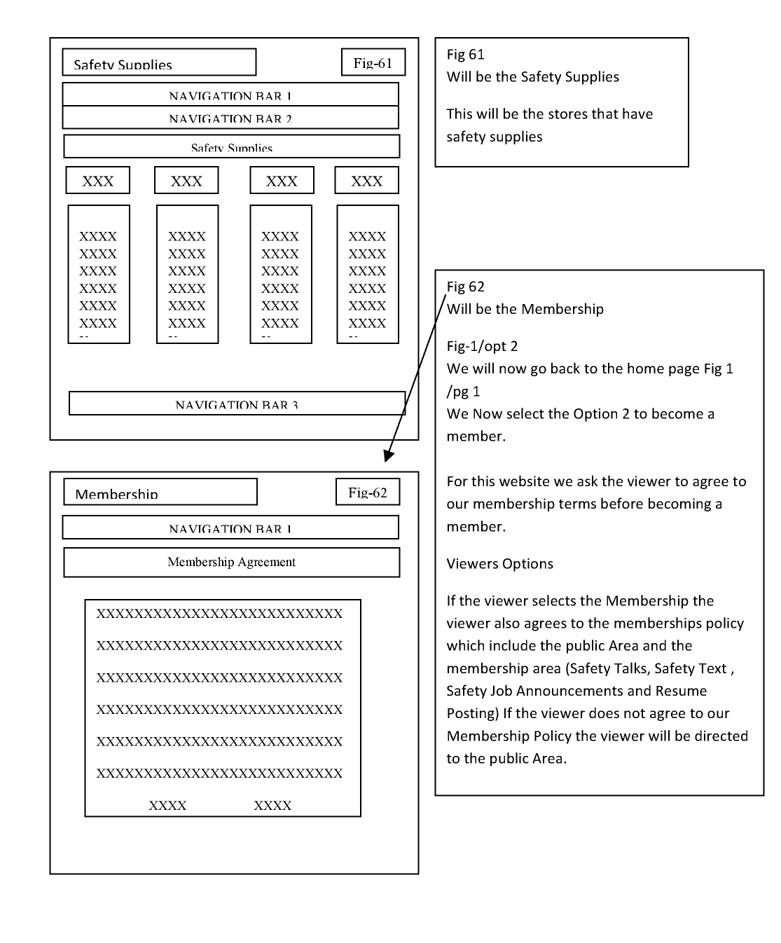

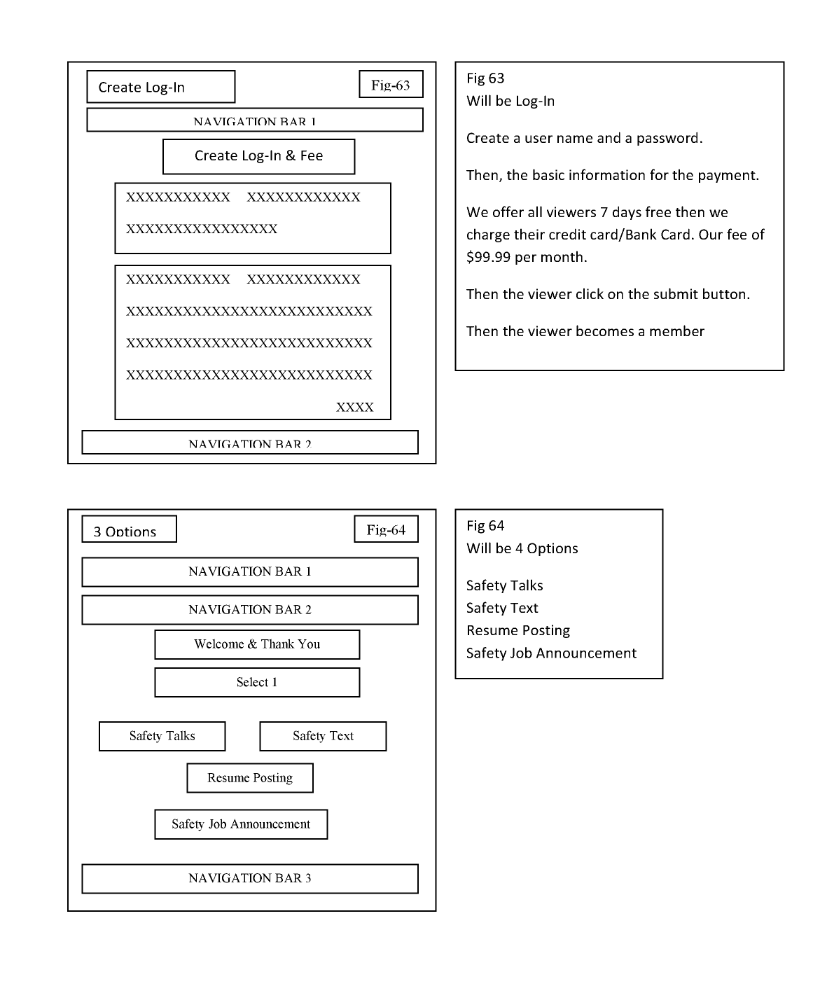

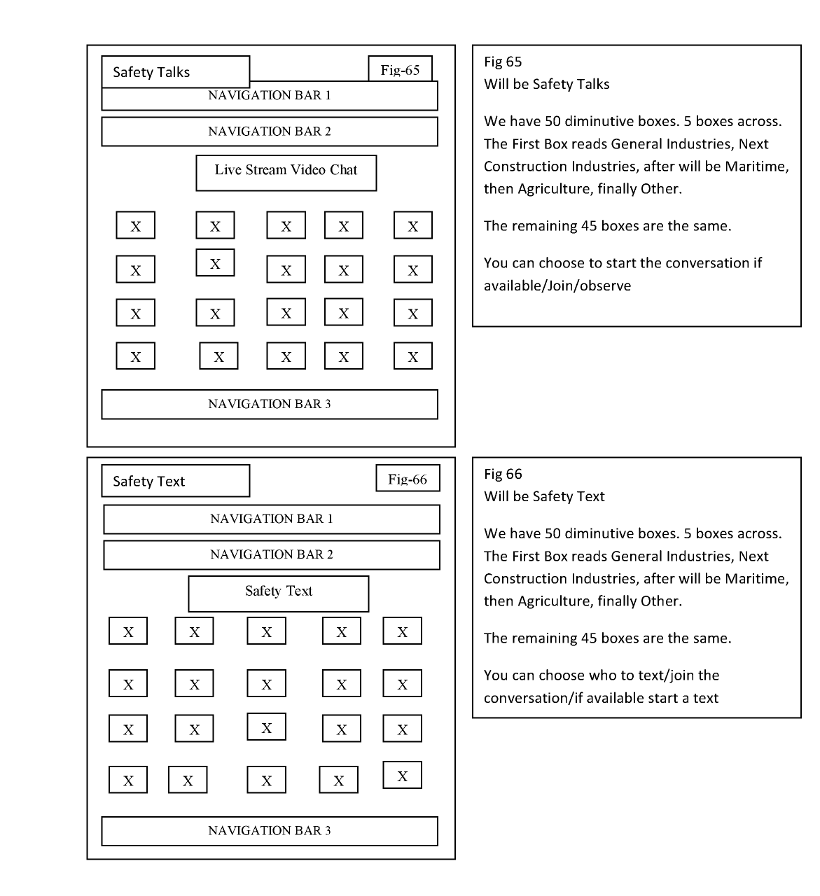

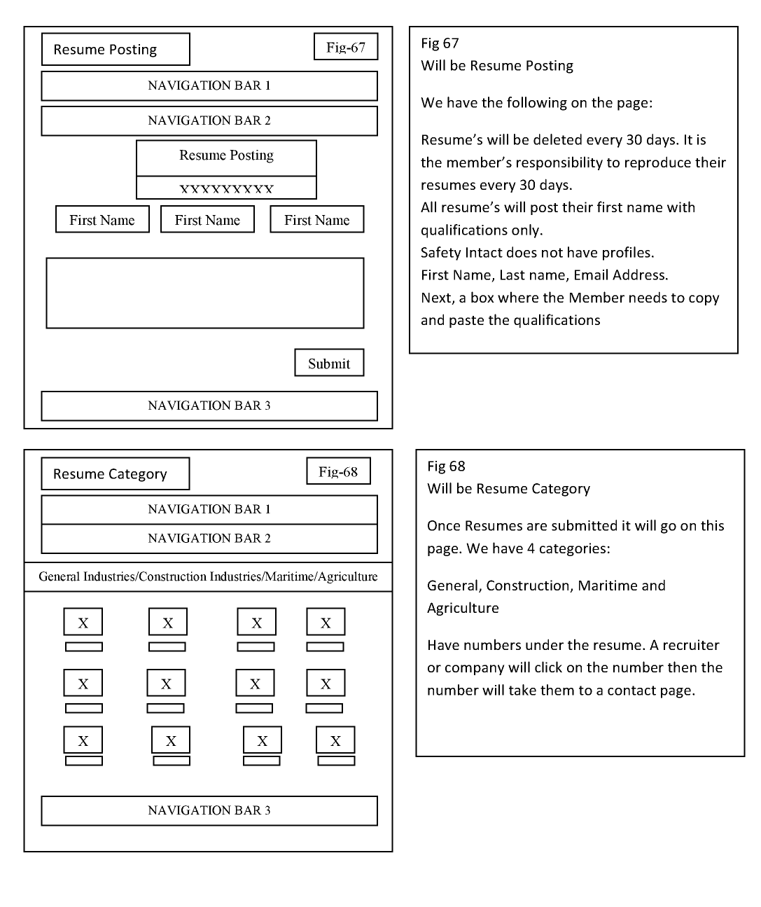

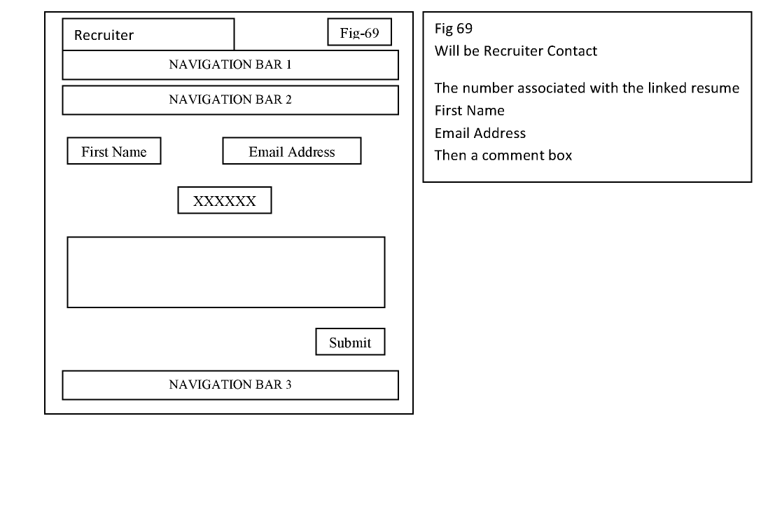

### DETAILED DESCRIPTION OF THE INVENTION:

Safety Intact is user friendly and has two parts to offer. The first part is the Public Area and is available to the public and will comprise of public domains to include Safety Links, Safety training, Reactive Videos/Images, and Safety Supplies. By clicking on each link you will be led to a separate homepage.

Individuals are able to access our links to government and federal safety laws and regulations by Sate and/or U.S. territory. In addition, find information regarding where to go for safety training and certifications. There will also be a list of numerous Universities who offer safety courses, classes and degree options. Next, there will be various stores listed whom offer safety equipment.

Within the new homepage there will be tabs that will read Federal links, State links, U.S. Territory links, Safety Training, Reactive Videos/Images, and Safety Supplies. When you do click on the Safety Links Tab, we will have a quick read to explain the following tabs

Quick Read will say this:

“The Freedom of Information Act (FOIA) is a law that gives you the right to access information from the federal government. It is often described as the law that keeps citizens in the know about their government (United States Department of Justice, n.d.)”.

All the safety links will be referenced and properly cited. We will comply with all Federal, State and U.S. Territories stipulations. Government Agencies are free to go onto our site and we can furnish the recording of tracking upon each Safety Intact's notice to our members.

### Federal Tab

Federal Links will have information regarding all federal laws and regulations. We will offer many different links to federal websites. By clicking on the federal tab users will be led to Safety Intact's subpage and are able to choose the links available. Upon doing so users are directed to that specific site and therefore leave Safety Intact.

### State Tab

State Links will have all the 50 states in alphabetical order. Upon choosing State users will be led to links available by each specific State. Upon clicking on a link, users will be directed to that exact States website. Therefore, users will leave Safety Intact's site.

### U.S. Territories Tab

U.S. Territories will have all the Territories listed District of Columbia, Marshall Islands, Micronesia, Northern Marianas, Puerto Rico and Virgin Islands. The Northern Marianas include Chuuk State, Kosrae State,Pohnpei State and Yap State. When a user clicks on the U.S. Territory, there will be links available to choose from. Upon clicking on a link, users will be directed to that specific territory's website and leave Safety Intact.

### Safety Training Tab

Safety Training is where an individual or companies pay for services to get certified so they can perform their jobs in a safe capacity. Our Safety Training tab will have links to each type of safety training available that are offered for free or otherwise. Upon clicking on the type of training you're interested in you will enter that site and leave Safety Intact.

### Safety Supplies Tab

Safety supplies will offer links to stores that sale safety equipment from Personal Protective Equipment, and much more. By clicking the Safety Supplies tab users will be able to choose from numerous links of Stores available. Upon choosing a store, users will be directed to that specific stores website and leave Safety Intact.

### Reactive Videos/Images Tab

Graphic Videos/Images are links to accidents that have occurred. Provided for the use of educational and preventative purposes. When clicking on this tab we will have a warning sign similar to the following:

WARNING NEED TO BE 18 YEARS OR OLDER THE IMAGES/VIDEOS ARE EXTREMELY GRAPHIC

When a user enters they will be able to choose a link and at this time they will be directed to that link and leave Safety Intact's site.

The second part is for Members. In order to become a member, you must agree to our Terms of Use, Guideline Principles and Members Policy. Members must fill out a form and provide their first and last name, birthdate, email address and create a password. You are also required to input your credit card information with your billing address, which will be debited once a month for a set price of $99.99. We will offer a free 7-day trial. If a user's card is declined, no personal information will be collected. Upon completion the member is then taken to the “Members' homepage” which outlines Safety Talks, Safety Text Resume Posting, and Safety Job Announcements.

### Safety Talks Tab

Safety Talks will consist of people talking to each other in real time. Members will be able to see multiple safety professionals talking regarding various topics. They will be able to join in or listen in on the conversation, depending on whom the member chooses. The first name and credentials of said professional will be presented. We will offer 50 diminutive boxes with five rows across labeled General, Construction, Maritime, Agriculture, and Other. The remaining 45 boxes will be labeled the same. Upon clicking on a box, this person will be the only one that our members will see and will be able to establish a conversation, join in, or observe.

For instance, FaceTime, Tango, Instagram, LinkedIn, Snapchat and Skype are meant for private conversations and for sharing personal images and videos but are not seen as a safety platform. Safety Intact will not be for personal use but as a safety platform.

### Safety Text Tab

Safety Text is where members can communicate with one another through text. This concept comes from a construction standpoint. Toolbox talks as it is known in the construction world is a daily safety meeting that usually runs about five to ten minutes where a supervisor brings up items about safety that pertains to their specific work.

Whereas, our site will have Safety Text where members can text with one another regarding any and all safety issues. We will offer 50 diminutive boxes with five rows across labeled General, Construction, Maritime, Agriculture, and Other. The remaining 45 boxes will be labeled the same. Members' title, credentials or just their name will appear depending on if they posted their resume. Members will be able to start the conversation, join in and/or choose whom to text with.

### Resume Posting Tab

Resume Posting is optional for our members. If desired, a member will enter their first and last name, email address and copy and past their credentials which must be in the format of Times New Roman and 12 point font. We will have four different categories to choose from to post your resume: General Industry, Construction Industry, Maritime Industry and Agriculture. Other members will see members' first name and credentials only and personal information will not be made public. Members will be informed to remove all other personal information from their resume. If not, Safety Intact will remove such information. If a member chooses not to post their resume only the members first name will be seen. Each resume posted will be accompanied with a number and if a Recruiter and/or Company is interested in a specific resume they will click on the number associated with the resume. Interested parties will be guided to a section where they will need to input their first name and email address as well as a comment box. Once submitted Safety Intact will relay this information to the Member whom coincides with the resume number. Safety Job Announcements will also be offered for Members where we will have boxes with rows of four that will be labeled by General Industries, Construction Industries, Maritime Industries, and Agriculture Industries which will include contact information for interested parties' use. Recruiters and/or Companies will be able to post in Job Announcements for Members to view.

The navigation bar will have information including Home, About Us, Company, Contact Us, Federal Links, Guideline Principles, Membership, Members/Register, MSDS, Privacy Policy, Public Area, Reactive Videos/Images Safety Training, Safety Supplies, Search bar, State Links, U.S. Territory Links.

### Home Tab

Home tab will take users back to the homepage which outlines the two options offered by Safety Intact. The Public Area and the Membership Area.

### About Us Tab

Educate others about Safety. Give everyone a place to share; suggest, learn, educate themselves in safety. To ensure, protect and prevent.

Your opinions do matter, please contact us for suggestions and improvements to the SAFETY PLATFORM.

### Company Tab

Founded in 2014 by Tammy Alo. Will launch 2016. The site is currently Patent Pending with the United States Patent & Trademark Office. Located in Hawaii. Our duty is to Educate others about Safety. Give everyone a place to share; suggest, learn, educate themselves in safety. To ensure, protect and prevent. Your opinions do matter, please contact us for suggestions and improvements to the SAFETY PLATFORM.

### Contact Us Tab

For users to contact us they will need to enter their first name, last name, email address, gender, and a comment box will be provided. Once submitted, Safety Intact will contact a user in a timely manner.

### Guideline Principles Tab

To ensure the safety and privacy of others. Safety Intact has put together this GUIDELINE PRINCIPLES. Safety is the essential key to ALL. We have created a site for everyone, with Safety Talks and Safety Text. PLEASE respect others opinions, questions, feedback, discussion to help our members be more productive and successful by means of SAFETY. The principle guideline is to educate, ask questions, answer questions, regarding safety questions, concerns, and safety suggestions they may have. Safety Intact does know at times conversations will be heated but here at Safety Intact we ask that you try to be professional. You will need to provide reference answers. The information that is given, advice and otherwise will be liable on the person you associated with question and answer and vice versa. Safety Intact is not responsible for any liabilities, that may occur or otherwise. Check Safety Intact's Public Area, to be sure the information is accurate. Safety Intact will not tolerate Hate, bias, discrimination, or other inappropriate information and bullying. Safety Intact reserves the right to remove a person or deny access. Respect others referenced answers, be professional and be nice. Every safety question is appropriate, no matter how a person asks. DO NOT intimidate others. Safety Intact reserves the right to remove a person or deny access. Follow the law, do your due diligence, we do have the Public Area, take the time and do your research. Do not mislead anyone, we do not tolerate this type of behavior.

### Membership Tab

Membership Agreement: You as a member, agree to our Terms of Use, Guideline Principles, and Membership Agreement/Policy. You are entering a legally binding agreement. Please see the following: By accessing, browsing or using the www.safetyintact.com website or by selecting I Accept during the membership registration, you represent that you have read, understand and agree to be bound by the terms and conditions of this Membership Agreement hereinafter referred to as Agreement.

1. Nature of the Service: The Safety Community is not a social network facilitating the exchange of personal information between people. This socialization shall include sharing knowledge, skills, questions and concerns for ALL Safety. The Community provides to its member's benefits such as but not exclusive to: Safety Platform, to educate others about Safety. Give everyone a place to share; suggest, learn, educate themselves in safety. To ensure, protect and prevent. The Community works like an online Safety community.

2. User Registration and Information: Member shall fill in the correct information requested in the User Registration form on the site. Member shall be required to promptly update the User Information on the site. Member shall select last name, username and password during the User Registration process. Member shall be responsible for: a) all use of the Site made by the Members last name, username and password, and b) maintaining the confidentiality of the Members username and password.

3. Content: The Content includes Safety Talks, Safety Text, and Resume Posting only. Simply Safe LLC and its affiliates will have exclusive rights to post, display, copy the content in connection with the operation of the site.

4. Release: If the Member has a dispute with one or more other Members, the Member shall release the Safety Community (and its officers, directors, agents, subsidiaries, joint ventures and employees) from claims, demands and damages (actual and consequential) of every kind and nature, known and unknown, arising out of or in any way connected with such disputes.

5. Privacy: We have no profiles for the community but the Safety Community shall not sell or rent Members personal information. Simply Safe LLC shall store and process Members information on computers located in the United States that are protected by physical as well as technological security devices.

6. Indemnity: Member shall indemnify and hold the Community (and its officers, directors, agents, subsidiaries, joint ventures and employees) harmless from any claim or demand, including reasonable attorneys' fees, made by any third party due to or arising out of Members breach of this Agreement, or Members violation of any law or the rights of a third party.

7. No Agency: No agency, partnership, joint venture, employee-employer or franchiser-franchisee relationship is intended or created by this Agreement.

8. Terminating Membership: If you choose to retire or end your membership, all published information will remain on the Safety Platform.

9. Governing Law: This Agreement shall be construed under and governed in accordance with the laws of Hawaii.

10. Arbitration: Any dispute arising under this contract shall be resolved under the commercial arbitration rules of the American Arbitration Association.

11. Limitation of Liability: Member shall not hold the Safety Community and Simply Safe LLC responsible for other user Members content, actions or inactions.

12. Area: Membership area will be monitored and recorded to identify unauthorized attempts to upload or change information, or otherwise cause damage.

13. Age: You will need to be 18 years of age or older to establish an account with Safety Intact.

14. MEMBERS: To all members; Be sure to do research before after and during your session. The information that is given, advice and otherwise will be liable on the person you associated with the question and answer and vice versa. Safety Intact is not responsible for any liabilities, that may occur or otherwise. Check Safety Intact's Public Area or any other websites, books and so forth, to be sure the information is accurate. Members when you share or communicate using our SAFETY INTACTS services remember you are sharing with everyone on Safety Intact's member area. Safety Talks, if you share your personal/business information together with the advice, knowledge, skills or otherwise, remember you are sharing your information with all members who are online. Safety Talks, we keep this section live, therefore Safety Intact will reverse what was missed. If member is inactive for three minutes they will be disconnected. Safety Talks will be in thirty minute increments only. Safety Text, if you share your personal contact information on Safety Text, it will remain. Anything you share on Safety Text will remain. Safety Text will remain for six months. Member can scroll back for six months. Resume Posting; Every 30 days' resumes will be deleted. It is the responsibility of the Members to post a new resume. Please reference your communication. All users please do your due diligence and research your questions and answers. Safety Intact is not responsible for any liabilities, that may occur or otherwise. Check Safety Intact's Public Area, other websites, books and so forth to ensure the information is accurate. Closed Section: We have a section onsite reserved for PAID online classes. We respect your privacy. Any and all information collected on this site will be kept strictly confidential and will not be sold, or disclosed to third parties, unless authorized enforcement is required. As a member you will adhere to; Hate, bias, discrimination, or other inappropriate information and bullying. Safety Intact reserves the right to remove a person off or deny access. See the Guideline Principals. CANCEL: You can cancel your account at anytime, go to the contact us icon and write to us. If you do cancel your account we will not charge your account for the next month. If you are not satisfied you will need to notify us in writing for refunds. INFORMATION WE SHARE: To all ASP, CSP, CHST, STS, Safety Professionals, First Responders, Law Enforcement, Doctors, Students, Attorneys and so forth we do share your credentials, and first name on the Member Area. For members who do not post their resume or credentials, we will share your first name only. INFORMATION SAFETY INTACT DOES NOT SHARE: Safety Intact does not share the last name of members nor do we share your address, email and birth date. Upon posting your resume remove ALL members last name with your email address. If you do not remove your last name with your email address, Safety Intact will remove this for you to ensure your safety. It is not required to post your Resume. For ALL questions and feedback please click on the Contact page. As a member you will be posting your resume in a variety of category/s different categories; the groups are as follows; General, Construction, Maritime and Agriculture. You can place it where you choose. Your resume will be visible for 30 days; it will be your responsibility to re-post your resume after the 30 days. We will offer a Free 7 day trial; Simply Safe LLC Monthly fee of $99.99. Users can choose to agree and will become a Member and be taken to the Members homepage. Users can disagree and will be taken to the Public Area homepage.

### Members/Register

Users can click on this tab to register and enter their last name, create a username and password. Forgot password, forgot username, create an account, and submit are options to choose from.

### MSDS

Upon clicking on this tab users will leave Safety Intact and be guided to http://msdsdigital.com homepage.

### Privacy Policy Tab

Protecting your private information is our priority. This Statement of Privacy applies to the www.safetyintact.com and Simply Safe LLC and governs data collection and usage. For the purposes of this Privacy Policy, unless otherwise noted, all references to Simply Safe LLC include www.safetyintact.com, Safety Intact, www.safetyintact.com and www.simplysafe808.com. The Simply Safe LLC website is a Safety Platform site. By using the Simply Safe LLC website, you consent to the data practices described in this statement. TRUSTe Privacy Program is currently pending. We are consulting alternatives. This is pending for your approval; Simply Safe LLC is a licensee of the TRUSTe Privacy Program. TRUSTe is an independent organization whose mission is to build users' trust and confidence in the Internet by promoting the use of fair information practices. Because we want to demonstrate our commitment to your privacy, we have agreed to disclose our information practices and have our privacy practices reviewed for compliance by TRUSTe. If you have questions or concerns regarding this policy, you should first contact us at simplysafe@inbox.com. If you do not receive acknowledgement of your inquiry or your inquiry has not been satisfactorily addressed, you should contact TRUSTe at http://watchdog.truste.com/pvr.php?page=complaint. TRUSTe may serve as a liaison with us to resolve your concerns. Collection of your Personal Information: Simply Safe LLC may collect personally identifiable information, such as your name, address, email and birth date. If you purchase Simply Safe LLC's products and services, we collect billing and credit card information. This information is used to complete the purchase transaction. Simply Safe LLC may also collect anonymous demographic information, which is not unique to you, such as your age. We may gather additional personal or non-personal information in the future. Information about your computer hardware and software may be automatically collected by Simply Safe LLC. This information can include: your IP address, browser type, domain names, access times and referring website addresses. This information is used for the operation of the service, to maintain quality of the service, and to provide general statistics regarding use of the Simply Safe LLC website. Please keep in mind that if you directly disclose personally identifiable information or personally sensitive data through Simply Safe LLC's public message boards, this information may be collected and used by others. Simply Safe LLC encourages you to review the privacy statements of websites you choose to link to from Simply Safe LLC so that you can understand how those websites collect, use and share your information. Simply Safe LLC is not responsible for the privacy statements or other content on websites outside of the Simply Safe LLC website. Use of your Personal Information: Simply Safe LLC collects and uses your personal information to operate its website(s) and deliver the services you have requested. Simply Safe LLC may also use your personally identifiable information to inform you of other products or services available from Simply Safe LLC and its affiliates. Simply Safe LLC may also contact you via surveys to conduct research about your opinion of current services or of potential new services that may be offered. Simply Safe LLC does not sell, rent or lease its customer lists to third parties. Simply Safe LLC may share data with trusted partners to help perform statistical analysis, send you email or postal mail, provide customer support, or arrange for deliveries. All such third parties are prohibited from using your personal information except to provide these services to Simply Safe LLC, and they are required to maintain the confidentiality of your information. Simply Safe LLC will disclose your personal information, without notice, only if required to do so by law or in the good faith belief that such action is necessary to: (a) conform to the edict of the law or comply with legal process served on Simply Safe LLC or the site; (b) protect and defend the rights or property of Simply Safe LLC; and, (c) act under exigent circumstances to protect the personal safety of users of Simply Safe LLC, or the public. Security of your Personal Information: To secure your personal information from unauthorized access, use or disclosure, Simply Safe LLC uses the following: We will record and monitor all interactions for Safety issues. When personal information (such as a credit card number) is transmitted to other websites, it is protected through the use of encryption, such as the Secure Sockets Layer (SSL) protocol. Children Under Eighteen: Simply Safe LLC does not knowingly collect personally identifiable information from children under the age of eighteen. If you are under the age of eighteen, you must ask your parent or guardian for permission to use this website. Opt-Out & Unsubscribe: We respect your privacy and give you an opportunity to opt-out of receiving announcements of certain information. Users may opt-out of receiving any or all communications from Simply Safe LLC by clicking on the contact page. Changes to this Statement: Simply Safe LLC will occasionally update this Statement of Privacy to reflect company and customer feedback. Simply Safe LLC encourages you to periodically review this Statement to be informed of how Simply Safe LLC is protecting your information. Contact Information: Simply Safe LLC welcomes your questions or comments regarding this Statement of Privacy. If you believe that Simply Safe LLC has not adhered to this Statement, please contact Simply Safe LLC at: Simply Safe LLC, at simplysafe@inbox.com.

### Terms of Use

Agreement between user and www.safetyintact.com. Welcome to www.safetyintact.com. The www.safetyintact.com website (the “Site”) is comprised of various web pages operated by Simply Safe LLC www.safetyintact.com is offered to you conditioned on your acceptance without modification of the terms, conditions, and notices contained herein (the “Terms”). Your use of www.safetyintact.com constitutes your agreement to all such Terms. Please read these terms carefully, and keep a copy of them for your reference. www.safetyintact.com is a News and Information Site. We are a Safety Platform. To Educate others about All Safety. Give everyone a place to share; suggest, learn, educate themselves in safety. To ensure, protect and prevent. We do charge for membership only. One price for all. Electronic Communications: Visiting www.safetyintact.com or sending emails to Simply Safe LLC constitutes electronic communications. You consent to receive electronic communications and you agree that all agreements, notices, disclosures and other communications that we provide to you electronically, via email and on the Site, satisfy any legal requirement that such communications be in writing. Your account: If you use this site, you are responsible for maintaining the confidentiality of your account and password and for restricting access to your computer, and you agree to accept responsibility for all activities that occur under your account or password. You may not assign or otherwise transfer your account to any other person or entity. You acknowledge that Simply Safe LLC is not responsible for third party access to your account that results from theft or misappropriation of your account. Simply Safe LLC and its associates reserve the right to refuse, suspend or cancel service, terminate accounts, or remove or edit content in our sole discretion. Simply Safe LLC does not knowingly collect, either online or offline, personal information from persons under the age of eighteen. If you are under 18, you may not utilize www.safetyintact.com only with permission of a parent or guardian. Cancellation/Refund Policy: You can cancel your account at anytime, go to the contact us icon and write to us. If you do cancel your account. We will not charge your account for the next month. If you are not satisfied you will need to notify us in writing for refunds. Links to third party sites/Third party services: www.safetyintact.com contains links to other websites (“Linked Sites”). The Linked Sites are not under the control of Simply Safe LLC and/or Safety Intact is not responsible for the contents of any Linked Site, including without limitation any link contained in a Linked Site, or any changes or updates to a Linked Site. Simply Safe LLC is providing these links to you only as a convenience, and the inclusion of any link does not imply endorsement by Simply Safe LLC of the site or any association with its operators. Simply Safe LLC will not share the information the user published or any other information on www.safetyintact.com. No unlawful or prohibited use/Intellectual Property: You are granted a non-exclusive, non-transferable, revocable license to access and use www.safetyintact.com strictly in accordance with these terms of use. As a condition of your use of the Site, you warrant to Simply Safe LLC that you will not use the Site for any purpose that is unlawful or prohibited by these Terms. You may not use the Site in any manner which could damage, disable, overburden, or impair the Site or interfere with any other party's use and enjoyment of the Site. You may not obtain or attempt to obtain any materials or information through any means not intentionally made available or provided for through the Site. WE DO NOT HAVE PROFILES: All content included as part of the Service, such as text, graphics, logos, images, as well as the compilation thereof, and any software used on the Site, is the property of Simply Safe LLC or its suppliers and protected by other laws that protect intellectual property and proprietary rights. We are currently Patent Pending through the United States Patent & Trademark Office. You agree to observe and abide by all and other proprietary notices, legends or other restrictions contained in any such content and will not make any changes thereto. You will not modify, publish, transmit, reverse engineer, participate in the transfer or sale, create derivative works, or in any way exploit any of the content, in whole or in part, found on the Site. Simply Safe LLC content is not for resale. Your use of the Site does not entitle you to make any unauthorized use of any protected content, and in particular you will not delete or alter any proprietary rights or attribution notices in any content. You will use protected content solely for your personal use, and will make no other use of the content without the express written permission of owner Simply Safe LLC. You agree that you do not acquire any ownership rights in any protected content. We do not grant you any licenses, express or implied, to the intellectual property of Simply Safe LLC or our licensors except as expressly authorized by these Terms. Use of communication services: The Site may contain chat areas, news groups, forums, communities, and/or other message or communication facilities designed to enable you to communicate with the public at large or with a group (collectively, “Communication Services”), you agree to use the Communication Services only to post, send and receive messages and material that are proper and related to the particular Communication Service. By way of example, and not as a limitation, you agree that when using a Communication Service, you will not: defame, abuse, harass, stalk, threaten or otherwise violate the legal rights (such as rights of privacy and publicity) of others; publish, post, upload, distribute or disseminate any inappropriate, profane, defamatory, infringing, obscene, indecent or unlawful topic, name, material or information; upload files that contain software or other material protected by intellectual property laws (or by rights of privacy of publicity) unless you own or control the rights thereto or have received all necessary consents; upload files that contain viruses, corrupted files, or any other similar software or programs that may damage the operation of another's computer; advertise or offer to sell or buy any goods or services for any business purpose, unless such Communication Service specifically allows such messages; conduct or forward surveys, contests, pyramid schemes or chain letters; download any file posted by another user of a Communication Service that you know, or reasonably should know, cannot be legally distributed in such manner; falsify or delete any author attributions, legal or other proper notices or proprietary designations or labels of the origin or source of software or other material contained in a file that is uploaded, restrict or inhibit any other user from using and enjoying the Communication Services; violate any code of conduct or other guidelines which may be applicable for any particular Communication Service; harvest or otherwise collect information about others, including e-mail addresses, without their consent; violate any applicable laws or regulations. Simply Safe LLC will monitor and record the Communication Services. However, Simply Safe LLC reserves the right to review materials posted to a Communication Service and to remove any materials in its sole discretion. Simply Safe LLC reserves the right to terminate or suspend your access to any or all of the Communication Services at any time without notice for any reason whatsoever. Simply Safe LLC reserves the right at all times to disclose any information as necessary to satisfy any applicable law, regulation, legal process or governmental request, or to edit, refuse to post or to remove any information or materials, in whole or in part, in Simply Safe LLC's sole discretion. This is a Safety Platform, always use caution when giving out any personal information about yourself and/or Company in any Communication Service. Simply Safe LLC does not control or endorse the content, messages or information found in any Communication Service and, therefore, Simply Safe LLC specifically disclaims any liability with regard to the Communication Services and any actions resulting from your participation in any Communication Service. Managers and hosts are not authorized Simply Safe LLC spokespersons, and their views do not necessarily reflect those of Simply Safe LLC. WE DO NOT HAVE PROFILES: Resumes are allowed to be posted THIS IS NOT A SOCIAL MEDIA WEBSITE, THIS IS A SAFETY PLATFORM. Materials provided to www.safetyintact.com or posted on any Simply Safe LLC web page Simply Safe LLC does not claim ownership of the materials you provide to www.safetyintact.com including feedback and suggestions, resumes and safety job announcements. Input or submit to any Simply Safe LLC Site or our associated services (collectively “Submissions”). However, by posting your Resume to Safety Intact you are granting Simply Safe LLC to post your resume in the different categories the user chooses. By posting, inputting, providing or submitting your Submission you warrant and represent that you own or otherwise control all of the rights to your Submission as described in this section including, without limitation, all the rights necessary for you to provide, post, input or submit the Submissions. International Users: The Service is controlled, operated and administered by Simply Safe LLC from our offices within the USA. If you access the Service from a location outside the USA, you are responsible for compliance with all local laws. You agree that you will not use the Simply Safe LLC Content accessed through www.safetyintact.com in any country or in any manner prohibited by any applicable laws, restrictions or regulations. Indemnification: You agree to indemnify, defend and hold harmless Simply Safe LLC, its officers, directors, employees, agents and third parties, for any losses, costs, liabilities and expenses (including reasonable attorneys' fees) relating to or arising out of your use of or inability to use the Site or services, any user postings made by you, your violation of any terms of this Agreement or your violation of any rights of a third party, or your violation of any applicable laws, rules or regulations. Simply Safe LLC reserves the right, at its own cost, to assume the exclusive defense and control of any matter otherwise subject to indemnification by you, in which event you will fully cooperate with Simply Safe LLC in asserting any available defenses. Liability disclaimer:

THE INFORMATION, SOFTWARE, PRODUCTS, AND SERVICES INCLUDED IN OR AVAILABLE THROUGH THE SITE MAY INCLUDE INACCURACIES OR TYPOGRAPHICAL ERRORS. CHANGES ARE PERIODICALLY ADDED TO THE INFORMATION HEREIN. SIMPLY SAFE LLC AND/OR ITS SUPPLIERS MAY MAKE IMPROVEMENTS AND/OR CHANGES IN THE SITE AT ANY TIME. SIMPLY SAFE LLC AND/OR ITS SUPPLIERS MAKE NO REPRESENTATIONS ABOUT THE SUITABILITY, RELIABILITY, AVAILABILITY, TIMELINESS, AND ACCURACY OF THE INFORMATION, SOFTWARE, PRODUCTS, SERVICES AND RELATED GRAPHICS CONTAINED ON THE SITE FOR ANY PURPOSE. TO THE MAXIMUM EXTENT PERMITTED BY APPLICABLE LAW, ALL SUCH INFORMATION, SOFTWARE, PRODUCTS, SERVICES AND RELATED GRAPHICS ARE PROVIDED “AS IS” WITHOUT WARRANTY OR CONDITION OF ANY KIND. SIMPLY SAFE LLC AND/OR ITS SUPPLIERS HEREBY DISCLAIM ALL WARRANTIES AND CONDITIONS WITH REGARD TO THIS INFORMATION, SOFTWARE, PRODUCTS, SERVICES AND RELATED GRAPHICS, INCLUDING ALL IMPLIED WARRANTIES OR CONDITIONS OF MERCHANTABILITY, FITNESS FOR A PARTICULAR PURPOSE, TITLE AND NON-INFRINGEMENT. TO THE MAXIMUM EXTENT PERMITTED BY APPLICABLE LAW, IN NO EVENT SHALL SIMPLY SAFE LLC AND/OR ITS SUPPLIERS BE LIABLE FOR ANY DIRECT, INDIRECT, PUNITIVE, INCIDENTAL, SPECIAL, CONSEQUENTIAL DAMAGES OR ANY DAMAGES WHATSOEVER INCLUDING, WITHOUT LIMITATION, DAMAGES FOR LOSS OF USE, DATA OR PROFITS, ARISING OUT OF OR IN ANY WAY CONNECTED WITH THE USE OR PERFORMANCE OF THE SITE, WITH THE DELAY OR INABILITY TO USE THE SITE OR RELATED SERVICES, THE PROVISION OF OR FAILURE TO PROVIDE SERVICES, OR FOR ANY INFORMATION, SOFTWARE, PRODUCTS, SERVICES AND RELATED GRAPHICS OBTAINED THROUGH THE SITE, OR OTHERWISE ARISING OUT OF THE USE OF THE SITE, WHETHER BASED ON CONTRACT, TORT, NEGLIGENCE, STRICT LIABILITY OR OTHERWISE, EVEN IF SIMPLY SAFE LLC OR ANY OF ITS SUPPLIERS HAS BEEN ADVISED OF THE POSSIBILITY OF DAMAGES. BECAUSE SOME STATES/JURISDICTIONS DO NOT ALLOW THE EXCLUSION OR LIMITATION OF LIABILITY FOR CONSEQUENTIAL OR INCIDENTAL DAMAGES, THE ABOVE LIMITATION MAY NOT APPLY TO YOU. IF YOU ARE DISSATISFIED WITH ANY PORTION OF THE SITE, OR WITH ANY OF THESE TERMS OF USE, YOUR SOLE AND EXCLUSIVE REMEDY IS TO DISCONTINUE USING THE SITE. Termination/access restriction: Simply Safe LLC reserves the right, in its sole discretion, to terminate your access to the Site and the related services or any portion thereof at any time, without notice. To the maximum extent permitted by law, this agreement is governed by the laws of the State of Hawaii and you hereby consent to the exclusive jurisdiction and venue of courts in Hawaii in all disputes arising out of or relating to the use of the Site. Use of the Site is unauthorized in any jurisdiction that does not give effect to all provisions of these Terms, including, without limitation, this section. You agree that no joint venture, partnership, employment, or agency relationship exists between you and Simply Safe LLC as a result of this agreement or use of the Site. Simply Safe LLC's performance of this agreement is subject to existing laws and legal process, and nothing contained in this agreement is in derogation of Simply Safe LLC's right to comply with governmental, court and law enforcement requests or requirements relating to your use of the Site or information provided to or gathered by Simply Safe LLC with respect to such use. </p><p>If any part of this agreement is determined to be invalid or unenforceable pursuant to applicable law including, but not limited to, the warranty disclaimers and liability limitations set forth above, then the invalid or unenforceable provision will be deemed superseded by a valid, enforceable provision that most closely matches the intent of the original provision and the remainder of the agreement shall continue in effect. Unless otherwise specified herein, this agreement constitutes the entire agreement between the user and Simply Safe LLC with respect to the Site and it supersedes all prior or contemporaneous communications and proposals, whether electronic, oral or written, between the user and Simply Safe LLC with respect to the Site. </p><p>A printed version of this agreement and of any notice given in electronic form shall be admissible in judicial or administrative proceedings based upon or relating to this agreement to the same extent and subject to the same conditions as other business documents and records originally generated and maintained in printed form. It is the express wish to the parties that this agreement and all related documents be written in English. Changes to Terms: Simply Safe LLC reserves the right, in its sole discretion, to change the Terms under which www.safetyintact.com is offered. </p><p>The most current version of the Terms will supersede all previous versions. Simply Safe LLC encourages you to periodically review the Terms to stay informed of our updates. Contact Us: Simply Safe LLC welcomes your questions or comments regarding the Terms: Simply Safe LLC 91-565 Kuilioloa Place QQ5 Ewa Beach, Hawaii 96706, Email Address:simplysafe@inbox.com, Telephone number (808) 308-4804.

1. Toolbox text is a safety platform software where users must register to become a member; required to pay a monthly fee, and then are able to chat with other members and Safety Professionals regarding different safety topics.

2. Safety Talks is a safety platform software where users must register to become a member; required to pay a monthly fee, communicate through video messaging with members and Safety Professionals regarding different safety topics.
